(19) United States
(12) Patent Application Publication
(10) Pub. No.: US 2025/0280767 A1
(43) Pub. Date: Sep. 11, 2025

(54) Variable Force Compound Cutting Lopper

(71) Applicant: Paul Janson, Porter Ranch, CA (US)

(72) Inventor: Paul Janson, Porter Ranch, CA (US)

(21) Appl. No.: 19/214,620

(22) Filed: May 21, 2025

Related U.S. Application Data
(63) Continuation-in-part of application No. 18/831,061, filed on May 28, 2024.
(60) Provisional application No. 63/527,199, filed on Jul. 17, 2023.

(51) Int. Cl. A01G 3/02; A01G 3/025

(52) U.S. Cl. CPC A01G 3/021; A01G 3/0251

(57) ABSTRACT

Variable force compound gear lopper devices and methods that produce a pinching effect of the handles which comes into play only after the wood, branch, is in the jaws. Once the wood, such as a branch, is in the jaws it causes a countering force which allow the new handle arrangement to cause the frame to rotate slightly on the hook side against the work opposite the cutting blade. So, in effect there is a double compound action against the work. A true double compound pinching effect against the work from both sides of the lopper. With the old version the frame is static and the only action is from the blade side. The variable force lopper has an upper handle; a lower handle connected by a cutting head with upper and lower arms therebetween, with an upper jaw and a lower jaw; and having a slot in the lower arm for the upper jaw.

### CROSS REFERENCES TO RELATED APPLICATIONS

The present application is a Continuation-In-Part of U.S. patent application Ser. No. 18/831,061 filed May 28, 2024, which claims the benefit of provisional patent application 63/527,199, filed Jul. 17, 2023, by Paul Janson, entitled, “VARIABLE FORCE COMPOUND ACTION CUTTING TOOL WITH ADDITIONAL DOUBLE COMPOUND LEVERAGE”. The entire disclosure of each of the applications listed in this paragraph are incorporated herein by specific reference thereto.

### BACKGROUND OF THE INVENTION

### Field of the Invention

The present invention relates generally to devices for cutting branches, and, in particular, relates to manual devices and methods for cutting, and, in greater particularity, relates to manual devices with a cutting head for holding and cutting large branches.

### Description of the Prior Art

Being able to cut large diameter branches from 1 to 2 inches requires the use of sufficient force to do it in one cut. Numerous products are available that attempt this task. Shears are not able to cut such branches since longer handles are required to develop sufficient torque and additional features may also be required.

One device shown is in U.S. Pat. No. 5,020,222 issued Jun. 4, 1991, to Gosselin et al., assigned to Fiskars, entitled: “Variable Force Compound Action Leverage Tool”, which is incorporated by reference. These are solely “hand-operated” due to the short handles and are thus limited in the diameter of branches cut. The use of arms, not just the squeezing of the fingers, to operate the cutting device is needed for larger diameter branches as well as having longer handles to transmit the torque from the longer handles to the cutting blades that are pivoted to the handles. It would be impossible to develop such torque by use of fingers and one hand to cut a large diameter branch.

Additional loppers having a “variable force” assigned to Fiskars include: U.S. Patents: U.S. Pat. Nos. 5,570,510 and 5,689,888 to Linden, which are both incorporated by reference, and U.S. Pat. No. 8,046,924 to Block et al., which is incorporated by reference.

FIG. 1 is a side view of a prior art lopper 13 having two pivots 15 and 17 and a slot 19 of a prior art lopper 13

The subject inventor has invented numerous compound leverage cutting hand tools. See for example, U.S. Pat. Nos. 6,408,725; 7,346,991; and 7,444,851 to Janson, which are all incorporated by reference in their entirety.

Accordingly, there is a need for a compound gear lopper having additional cutting forces available.

### SUMMARY OF THE INVENTION

A primary objective of the variable force compound action cutting lopper with additional double compound levers provides additional cutting force to shear large diameter branches.

The variable force compound lopper that produces a pinching effect of the handle which comes into play only after the wood, branch, is in the jaws. Once the wood is in the jaw it causes a countering force which allow the new handle arrangement to cause the frame to rotate slightly on the hook side of the jaws against the work opposite the cutting blade. So, in effect you have a double compound action against the work. A true double compound pinching effect against the work from both sides of the lopper. With The old version the frame is static and the only action is from the blade side. The present invention thus comprises: an upper rotating cutting blade being convex connected into a slotted arm in the lower handle arm, and connected to a pivot on the rotating lower blade, the slotted arm connected into a lower handle arm and to a central pivot; the lower rotating cutting blade connected to an upper handle arm, to the central pivot and also pivoted to the upper cutting blade, and the upper handle arm connected to the lower rotating cutting blade at the central pivot and to the handle upper arm and to the upper rotating cutting blade at another pivot.

It is another object of the present invention to provide a lopper for cutting large branches by the use of a variable force compound action cutting tool with additional double compound leverage;

It is still another object of the present invention to provide a lopper where the applied force is multiplied by use of force multiplying connecting arms and levers;

It is a further object of the present invention to provide a lopper having no gear sections;

It is still a further object of the present invention to provide lopper than can easily cut approximately 2-inch-wide branches;

It is still another object of the present invention to provide a lopper that is easily manufactured; and

It is still another object of the present invention to provide a lopper that is comparable in price to non-compound gear loppers.

These and other objects, features, and advantages of the present invention will become more readily apparent from the attached drawings and the detailed description of the preferred embodiments, which follow.

### BRIEF DESCRIPTION OF THE DRAWINGS

FIG. 1 is a side view of a lopper having two pivots and a slot of a prior art lopper;

FIG. 2 is front, of the present invention showing three pivots and a slotted connector in a closed position;

FIG. 3 is an enlarged front view of the lopper head, of FIG. 2 in a closed position having three pivots and two arms and two cutting blades;

FIG. 4 is an enlarged rear view, of FIG. 3 showing the position of the rotating cutting blades and the fixed arms (#1 and #2) in the handles partially shown.

FIG. 5 is an exploded view of the cutting blades (#3 and “#4), and two fixed arm (#1 and #2) of FIG. 4 of the present invention showing their relative positions with nuts and bolts of the pivots;

FIG. 6 is a perspective view of the left side for the purpose of a cross section of the cutting blade levers of FIG. 5;

FIG. 7 is the cross sectional view of FIG. 6;

FIG. 8 is a left side view of the cutting head;

FIG. 9 is front view of the cutting head front assembly;

FIG. 10 is a right side view of the cutting head of FIG. 9;

FIG. 11 is a front view of the cutting head in a partially open position; and

FIG. 12 is another view of FIG. 11 but being fully open and further with a large branch therein;

FIG. 13 is another view of FIG. 12, but with the handles partially shown.

Like reference numerals refer to like parts throughout the several views of the drawings.

### DETAILED DESCRIPTION OF THE PREFERRED EMBODIMENTS

Before explaining the disclosed embodiments of the present invention in detail it is to be understood that the invention is not limited in its applications to the details of the particular arrangements shown since the invention is capable of other embodiments. Also, the terminology used herein is for the purpose of description and not of limitation.

In the Summary above and in the Detailed Description of Preferred Embodiments and in the accompanying drawings, reference is made to particular features (including method steps) of the invention. It is to be understood that the disclosure of the invention in this specification does not include all possible combinations of such particular features. For example, where a particular feature is disclosed in the context of a particular aspect or embodiment of the invention, that feature can also be used, to the extent possible, in combination with and/or in the context of other particular aspects and embodiments of the invention, and in the invention generally.

In this section, some embodiments of the invention will be described more fully with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will convey the scope of the invention to those skilled in the art. Like numbers refer to like elements throughout, and prime notation is used to indicate similar elements in alternative embodiments.

The variable force compound cutting lopper provides additional cutting force by means of compound levers that are uniquely oriented thereon. A listing of the components is now described.
1 upper arm
2 slotted connector
3 lower cutting jaw
4 upper cutting jaw
10 variable force lopper
12 upper handle
13 lopper (prior art)
14 lower handle
15 pivot (prior art)
17 pivot (prior art)
19 slot (prior art)
20 lower handle arm
22 arm tabs
24 lower cutting jaw
26 central pivot
28 flat head bolt
30 upper cutting jaw
32 cutting edge
34 upper pivot
36 cutting head
38 rear section arm
40 bolt
42 end
44 other end
46 lower pivot
50 partially open angle
60 fully open angle

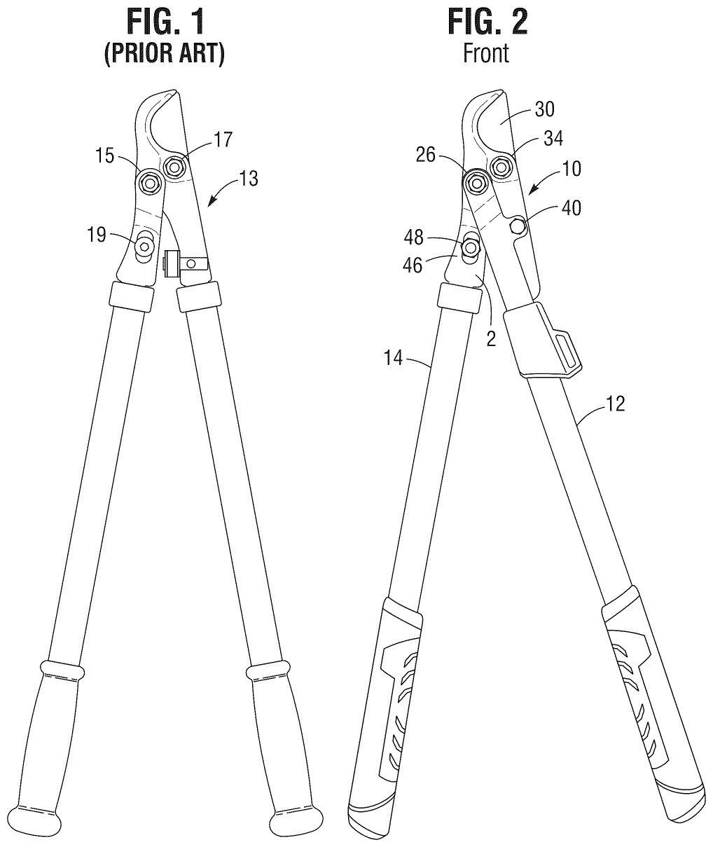

FIG. 1 is a side view of a lopper 13 having two pivots 15 and 17 and a slot 19 of a prior art lopper 13; FIG. 2 is a front view of the present invention 10 showing three pivots: a central pivot 26, an upper pivot 34, a lower pivot 46 sliding in a slot 48 of a slotted connector 50 in a closed position.

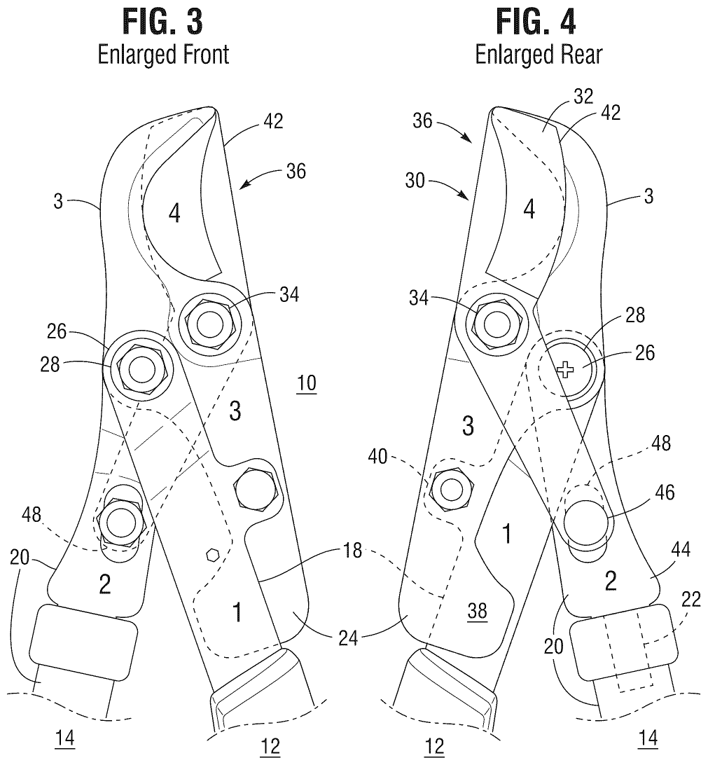

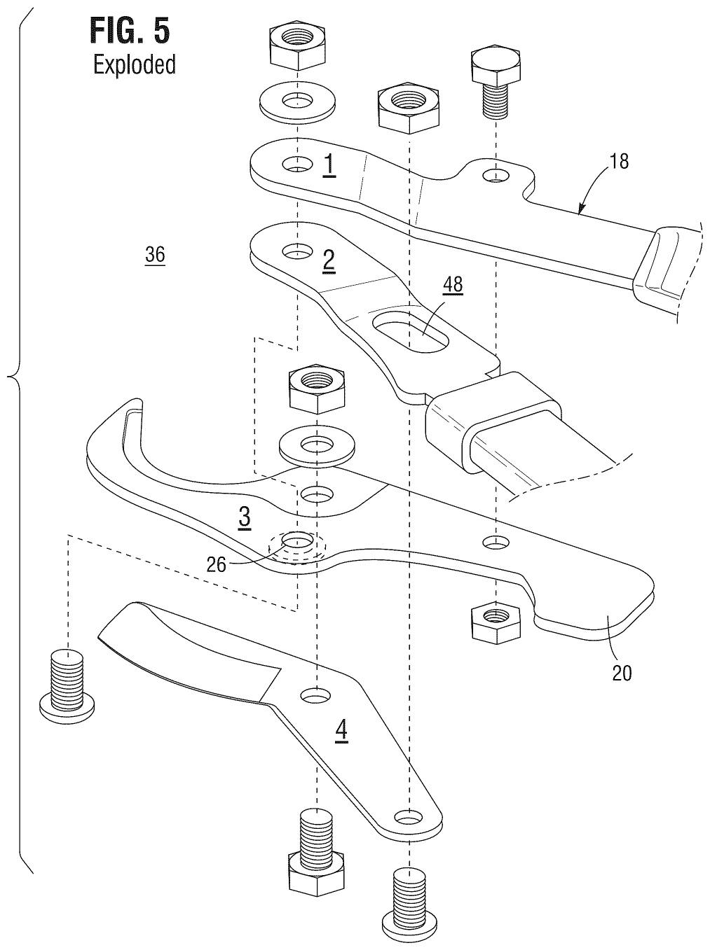

FIG. 3 is an enlarged front view of the cutting head 36. FIG. 4 is an enlarged rear view of the cutting head in FIG. 3. FIG. 5 shows an exploded perspective view of the number pieces of the cutting head 36. Item #4 is the upper cutting jaw 30, #3 is a lower cutting jaw 24, Item 2 is a slotted connector 48, and item #1 is an upper handle arm 18.

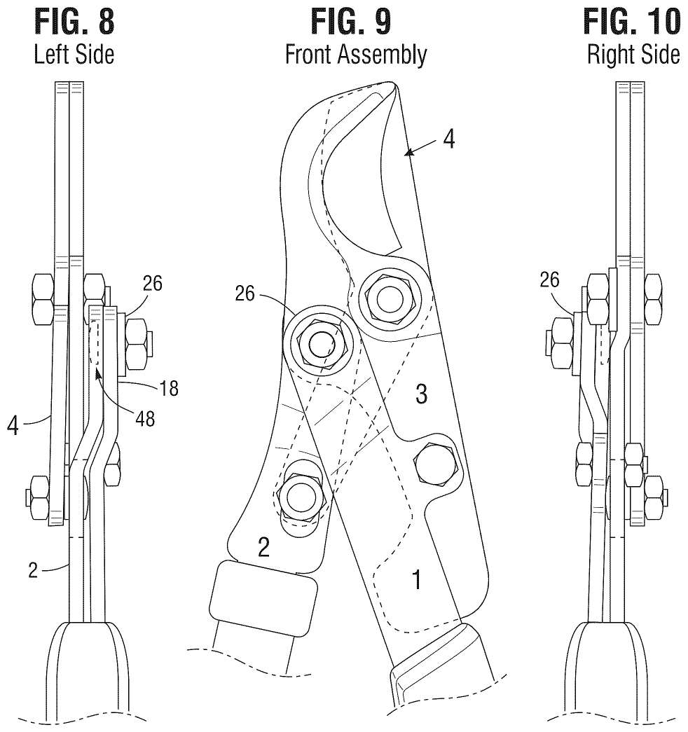

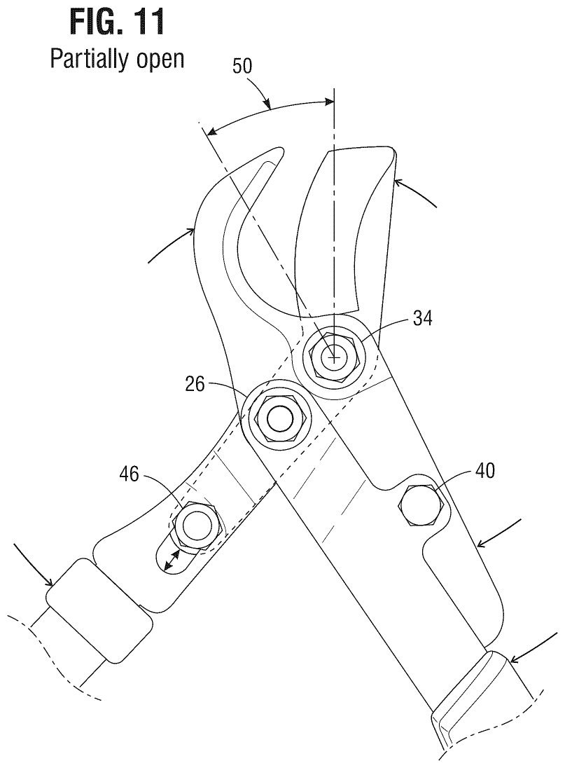

Further, FIG. 8 show a left side view of the variable force lopper 10 in a closed position. FIG. 10 shows a right view of the variable force lopper 10 in a closed position. An upper handle 12 and a lower handle 14 are partially shown. A cutting head 16 is therebetween. An upper handle arm 18 and a lower handle arm 20 being also noted as the slotter connector 48 are connected thereto by inserting arm tabs 22 only one shown in FIG. 4 into the upper handle 12 and the lower handle 14. The upper handle arm 18 is further not a part of the lower cutting jaw 24 by design. The lower cutting jaw 24 has a central pivot 26 having a flat head bolt 28 therein for allowing an upper jaw 30 to pass thereover when pivoted. Another pivot 34 allows the upper jaw 30 to rotate freely thereon. The upper jaw 30 has a cutting edge 32 facing downward into the lower cutting jaw 36 that is semi-circular shaped to hold a cutting piece partially open in FIG. 11. The lower cutting jaw 36 is a part of the lower jaw 24 being one piece that pivots on the central pivot 26. The lower cutting jaw 24 has a rear section arm 38 that is bolted 40 to the upper handle arm 18.

The upper cutting jaw 30 has the cutting edge 32 on one end 42 and on the other end 44 a pivot 46 the slides in a slotted portion or connector 48, but is located on the lower handle arm 20.

The upper handle arm—18 is also attached to the central pivot 26. The lower handle arm 20 is also attached to the central pivot 26, FIG. 5.

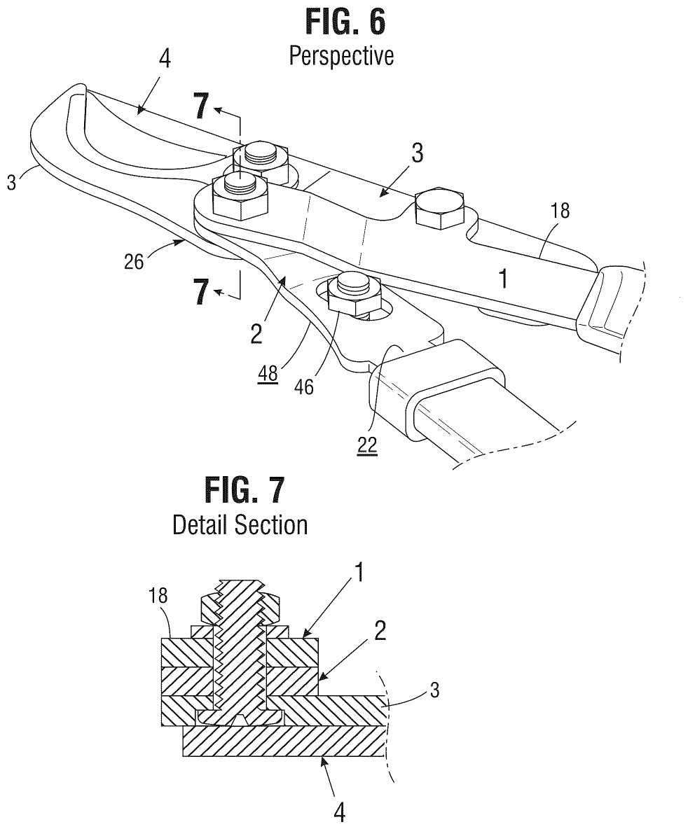

FIG. 6 shows a perspective view of the left side of the cutting head 16 for the purpose of a cross section line 7 of the cutting head 16 of FIG. 5;

FIG. 7 is the cross-sectional view of FIG. 6;

FIG. 8 is a left side view of the cutting head 16.

FIG. 9 is front view of the cutting head;

FIG. 10 is a right side view of the cutting head 16 of FIG. 9;

FIG. 11 is a front view of the cutting head in a partially open position with a branch therein; and

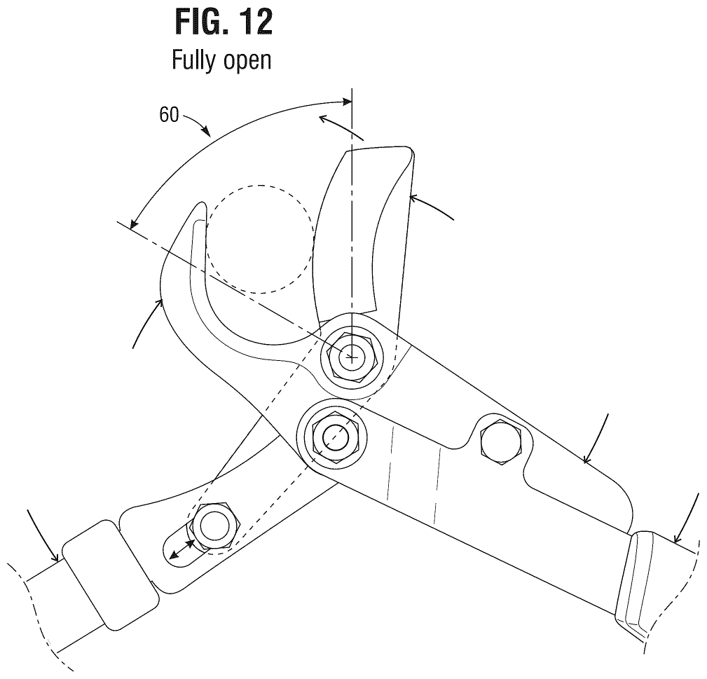

FIG. 12 is the same view of FIG. 11 but being fully open and further with a large branch therein;

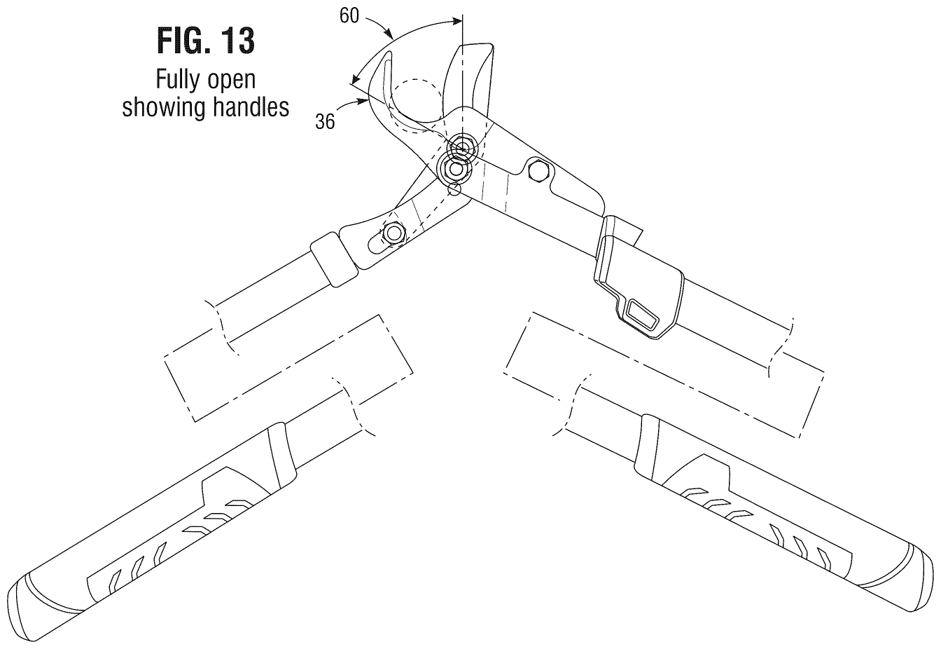

FIG. 13 is the same as FIG. 12, but with the handles partially shown.

In summary, a variable force compound cutting lopper comprises an upper handle; a lower handle, said upper handle and said lower handle being connected by means of a cutting head; said cutting head, said upper and said lower handles attached to said cutting head by an upper and lower handle arms, where said cutting head and said handle arms are connected to said cutting head at a common pivot, said cutting head having a rotational cutting head and having an opposite hook shaped portion on a lower cutting jaw, said cutting head and said lower cutting jaw is rotational about the common pivot point axis when work is placed in said cutting jaws, upper and lower cutting jaws; said upper cutting jaw blade is rotatably attached by a pivot to a lower cutting hooked jaw and also rotatably attached to a slotted pivot in said lower handle arm with a slotted connector; and said lower handle arm, being a slotted connector also, having a slot therein for said upper cutting jaw blade arm attaching at a slotted pivot in said slotted lower handle arm at said pivot; and rotatably connected to said central pivot by one end of said slotted connector.

The variable force compound cutting lopper as noted above has said lower cutting jaw being of a C-shaped cutting edge that closely engages to the upper cutting jaw that is blade shaped and is capable of holding an appropriately sized branch therein. The variable force compound lopper as noted above wherein said upper handle arm is connected to said lower cutting jaw at a second point arrears of the cutting blade pivot point wherein said upper handle arm and said lower handle arm are connected at a first common pivot point with said upper handle being connected at a second connection point arrears of the cutting blade pivot point allowing said upper handle to exert a leverage on the lower cutting jaw where the common pivot point with lower handle is a fulcrum to exert a rotational force on the lower jaw when work is placed between the cutting blades and the hooked lower cutting jaw.

The variable force compound cutting lopper as noted above has said upper and said lower handles being elongated handles and have a length of approximately 20 to approximately 30 inches and are adjustable in length. The variable force compound cutting lopper as noted above wherein said slot is approximately one half inch wide and one inch long oppositely located from said common pivot being the central pivot.

A variable force double compound cutting lopper comprises an upper and lower jaw where said upper jaw is an upper cutting blade and said lower jaw is a hooked structure where said upper cutting blade bypasses through said lower hooked structure, said upper cutting blade is pivotally attached to said lower hooked jaw at a first point and with two handles, an upper and lower handle are pivotally attached to lower hooked jaw at a common pivot point, where lower handle arm is pivotally attached to cutting blade arm by means of a slot in said lower handle slot connector; said upper handle arm being connected at a second point to said lower cutting jaw at a point behind the cutting blade pivot point. The variable force double compound lopper as described above wherein when work such as a branch is placed in the jaws the action of both handles sharing a common pivot point, a central pivot, behind the cutting blade pivot point creates a double compound force causing, the hooked portion of said lower jaw to rotate around the common handle pivot point into the work with extreme force against the cutting blade. The variable force double compound lopper as noted above wherein said upper handle is connected at a common pivot point with said lower handle and said upper handle is connected to a second point on the lower jaw arrears of said cutting blade pivot point, wherein said upper handle being connected at a first common pivot point with the lower handle and at a second point on the lower jaw arrears of the cutting blade pivot point, where said upper handles first pivot point acts as a fulcrum against said second handles connection point to the lower jaw arrears of the cutting blade pivot point, wherein a double compound action is exerted against the lower jaw to cause it to rotate around the lower and upper handle common pivot point connection.

The term “approximately”/“approximate”/about” can be +/−10% of the amount referenced. Additionally, preferred amounts and ranges can include the amounts and ranges referenced without the prefix of being approximately.

Although specific advantages have been enumerated above, various embodiments may include some, none, or all of the enumerated advantages.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

Since many modifications, variations, and changes in detail can be made to the described embodiments of the invention, it is intended that all matters in the foregoing description and shown in the accompanying drawings be interpreted as illustrative and not in a limiting sense. Thus, the scope of the invention should be determined by the appended claims and their legal equivalents.

1. A variable force compound cutting lopper, said variable force compound cutting lopper comprising:
an upper handle;
a lower handle, said upper handle and said lower handle being connected by means of a cutting head;
said cutting head, said upper and said lower handles attached to said cutting head by an upper and lower handle arms, wherein said cutting head and said handle arms are connected to said cutting head at a common pivot, said cutting head having a rotational cutting head and having an opposite hook shaped portion on a lower cutting jaw, said cutting head and said lower cutting jaw is rotational about the common pivot point axis when work is placed in said cutting jaws, upper and lower cutting jaws;
said upper cutting jaw blade rotatably attached by a pivot to a lower cutting hooked jaw and also rotatably attached to a slotted pivot in said lower handle arm with a slotted connector; and
said lower handle arm, being a slotted connector, having a slot therein for said upper cutting jaw blade arm attaching at a slotted pivot in said slotted lower handle arm at said pivot; and
rotatably connected to said central pivot by one end of said slotted connector.

2. The variable force compound cutting lopper as in claim 1, wherein said lower cutting jaw has a C-shaped cutting edge that closely engages to the upper cutting jaw that is blade shaped and is capable of holding an appropriately sized branch therein.

3. The variable force compound lopper as in claim 1 wherein said upper handle arm is connected to said lower cutting jaw at a second point behind the cutting blade pivot point wherein said upper handle arm and said lower handle arm are connected at a first common pivot point with said upper handle allowing said upper handle to exert a leverage on the lower cutting jaw where the common pivot point with lower handle is a fulcrum to exert a rotational force on the lower jaw when work is placed between the cutting blades and the hooked lower cutting jaw.

4. The variable force compound cutting lopper as in claim 1, wherein said upper and said lower handles are elongated handles and have a length of about 20 to about 30 inches and are adjustable in length.

5. The variable force compound cutting lopper as in claim 1, wherein said slot is approximately one half inch wide and approximately one inch long oppositely located from said common pivot.

6. A variable force double compound cutting lopper comprising an upper and lower jaw where said upper jaw is an upper cutting blade and said lower jaw is a hooked structure wherein said upper cutting blade bypasses through said lower hooked structure, said upper cutting blade is pivotally attached to said lower hooked jaw at a first point and with two handles, an upper and lower handle are pivotally attached to lower hooked jaw at a common pivot point, where lower handle arm is pivotally attached to cutting blade arm by means of a slot in said lower handle slot connector; said upper handle arm being connected at a second point to said lower cutting jaw at a point behind the cutting blade pivot point.

7. The variable force double compound lopper as in claim 6, wherein when work is placed in the jaws the action of both handles sharing a common pivot point behind the cutting blade pivot point creates a double compound force causing the hooked portion of said jaw to rotate around the common handle pivot point into the work with extreme force against the cutting blade.

8. The variable force double compound lopper as in claim 6, wherein said upper handle is connected at a common pivot point with said lower handle and said upper handle is connected to a second point on the lower jaw behind of said cutting blade pivot point, wherein said upper handle being connected at a first common pivot point acts as a fulcrum against said second handles connection point to the lower jaw behind of the cutting blade pivot point, wherein a double compound action is exerted against the lower jaw to cause it to rotate around the lower and upper handle common pivot point connection.

9. A variable force compound cutting lopper, said variable force compound cutting lopper comprising:
an upper handle;
a lower handle, said upper handle and said lower handle being connected by means of a cutting head, wherein said cutting head, said upper and said lower handles are attached to said cutting head by upper and lower handle arms;
an upper jaw, said upper jaw rotatably attached by a pivot to a lower jaw, and also rotatably attached to a slotted pivot in said lower handle arm; and
a lower jaw, said lower jaw pivoted to said upper jaw, and fixedly attached to said upper handle arm with a space therein for said lower handle arm at the central pivot, said upper handle arm and a slotter connector being cooperatively connected to a central pivot with said upper handle arm; and
said lower handle arm, said lower handle arm having a slot therein for said upper jaw at said pivot; and rotatably connected to said central pivot.

10. The variable force compound cutting lopper of claim 9, wherein the lower jaw has a C-shaped cutting edge that closely engages to the upper cutting jaw that is blade shaped and is capable of holding an appropriately sized branch therein.

11. The variable force compound cutting lopper as in claim 9, wherein said upper and said lower handles are elongated handles and have a length of about 20 to about 30 inches and are adjustable in length.

12. The variable force compound lopper as in claim 9 wherein said upper handle arm is connected to said lower cutting jaw at a second point behind the cutting blade pivot point wherein said upper handle arm and said lower handle arm are connected at a first common pivot point with said upper handle allowing said upper handle to exert a leverage on the lower cutting jaw where the common pivot point with lower handle is a fulcrum to exert a rotational force on the lower jaw when work is placed between the cutting blades and the hooked lower cutting jaw.

13. The variable force compound cutting lopper as in claim 9, wherein said slot is approximately one half inch wide and approximately one inch long oppositely located from said common pivot.

14. The variable force double compound lopper as in claim 9, wherein when work is placed in the jaws the action of both handles sharing a common pivot point behind the cutting blade pivot point creates a double compound force causing the hooked portion of said jaw to rotate around the common handle pivot point into the work with extreme force against the cutting blade.
